(19) United States
(12) Patent Application Publication
(10) Pub. No.: US 2004/0066125 A1
(43) Pub. Date: Apr. 8, 2004

(54) Platinun alloy composition for a spark plug electrode for an internal combustion engine

(76) Inventor: Sophie Beaudet, Ballau Mire (FR)

Correspondence Address: FOLEY & LARDNER, 777 EAST WISCONSIN AVENUE, SUITE 3800, MILWAUKEE, WI, 53202-5308, US

(21) Appl. No.: 10/467,967

(22) PCT Filed: Feb. 6, 2002
(86) PCT No.: PCT/FR02/00461

(30) Foreign Application Priority Data
Feb. 14, 2001 (FR) 01/01994

(51) Int. Cl. H01T 13/20

(52) U.S. Cl. 313/140

(57) ABSTRACT

A platinum alloy composition for the central electrode (1) of a spark plug for a spark ignition engine, the composition further comprising in percentage by weight:

about 5% to 15% iridium; and

about 0.1% to 5% of an element selected from the group comprising: hafnium, zirconium, and mixtures thereof.

The present invention relates to a platinum alloy composition for a spark plug electrode for a spark ignition engine.

Manufacturers continue to seek to lengthen the lifetime of spark plugs in order to comply with new administrative regulations, new maintenance constraints, and an increase in the lifetime of spark plugs (at least 120,000 kilometers).

One of the phenomena that limits the lifetime of spark plugs consists in deterioration of the central electrode of the spark plug. Techniques are known which make it possible to improve the wear resistance and the performance of spark plugs. Those techniques rely essentially on reinforcing laser-welded electrodes by adding tips made of noble metal alloy.

Thus, tips made of platinum-based alloy including additions of nickel, or of noble metals (e.g. rhodium, iridium), have been developed.

Nevertheless, endurance tests have shown that the wear resistance of such alloys is limited.

A particular object of the present invention is to mitigate that drawback.

To this end, according to the invention, the platinum alloy composition for the central electrode of a spark plug for a spark ignition engine further comprises, in percentage by weight:

about 5% to 15% iridium; and

about 0.1% to 5% of an element selected from the group comprising hafnium, zirconium, and mixtures thereof.

By means of these dispositions, the resistance of the central electrodes of spark plugs to wear by oxidation and/or chemical corrosion and by electrical erosion is improved.

In preferred embodiments of the invention, it is also possible optionally to make use also of one or more of the following dispositions:

the platinum alloy contains rhodium, at a content of no more than 15%;

the selected element is present in the form of a metal;

the selected element is introduced in the form of a metal; and

the alloy composition is applied to an end portion of the central electrode.

According to yet another aspect of the invention, it provides a spark plug for a spark ignition engine in which the end portion of the central electrode is made of the above-specified platinum alloy.

Other characteristics and advantages of the present invention appear from the following description of an embodiment, given by way of non-limiting example and with reference to the figures, in which:

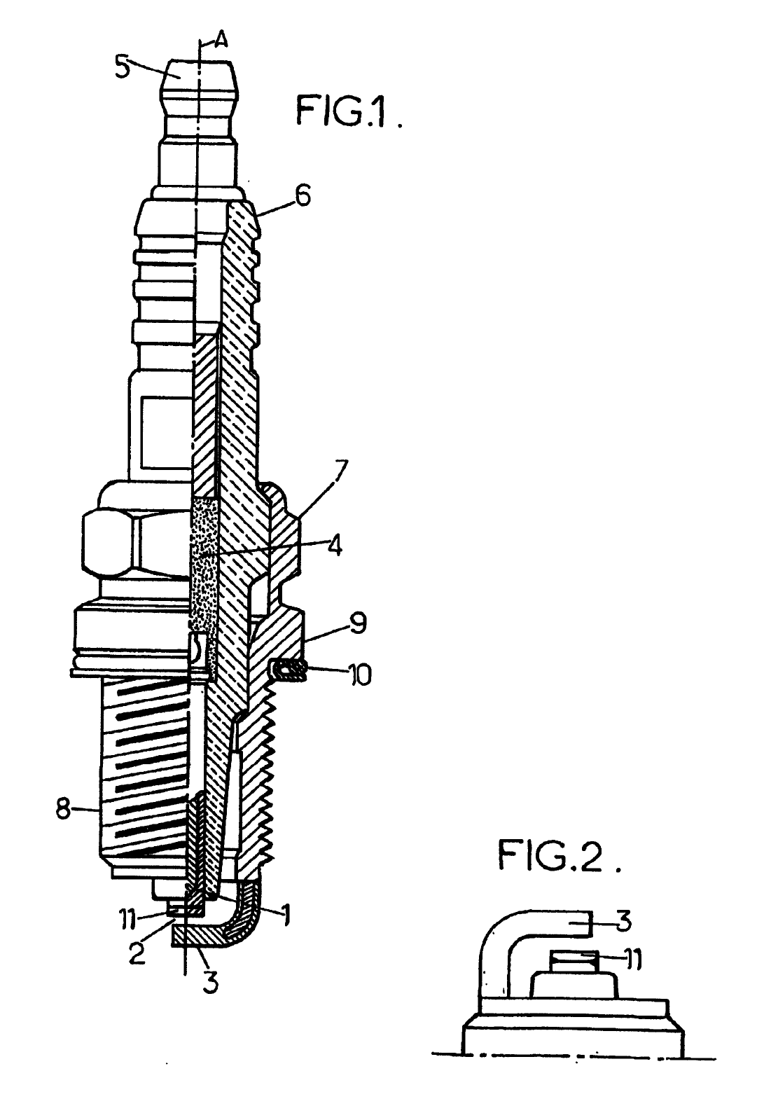

FIG. 1 is a side elevation view of a spark plug for a spark ignition engine, in which the central electrode comprises a platinum alloy of the invention; and

FIG. 2 is a side elevation view on a larger scale of the end of the spark plug, in the vicinity of its central electrode.

With reference to FIG. 1, a central electrode 1 is positioned coaxially on the main axis A of a spark plug 8 and co-operates with a ground electrode 3 to define a gap 2, which gap defines the location in which a spark occurs.

The distal portion of the central electrode 1, generally a bimetallic electrode, extends from a core 4 made for example out of a conductive or a resistive cement, and it possesses excellent heat conduction properties, the core 4 itself being connected to a connector member 5 suitable for being connected to an external electrical circuit (not shown).

An electrically insulating body 6, in particular made of ceramic and substantially tubular in shape, surrounds said central portion.

In conventional manner, the ground electrode 3 is made integrally with an outer metal portion 7, commonly referred to as the spark plug body, which also includes a threaded portion 8 for connection to the engine, a portion 9 having flats for mounting and removing the spark plug, and sealing means 10 which are either in the form of a separate gasket, or made integrally with the body, generally in the form of a conical bearing surface.

In an embodiment of the invention, a platinum alloy is used for making the end portion 11 of the central electrode 1 (cf. FIG. 2), the end portion 11 being in fact the portion of the central electrode that is placed facing the ground electrode, this portion being the portion which is likely to become worn by the presence of sparks. Given the cost of making a platinum alloy, only the end portion, generally of small thickness, is made of said platinum alloy, with this end portion being fitted, in particular by a welding technique to the end of the central electrode.

The platinum alloy includes oxidizable elements which are selected from those which have a high melting point, and whose solid oxides are stable at high temperature, while their gaseous oxides are unstable at said high temperatures.

Thus, preferably, the platinum alloy includes, in metal form: hafnium, zirconium, at concentrations lying in the range 0% to 5% by weight, with the threshold value of 5% corresponding to a limit that is reached because of the poor solubility of those elements in platinum, with at least one of those two elements being present in the alloy composition at a concentration of not less than 0.1% by weight.

The platinum alloy also has other elements whose melting point temperature is likewise above that of platinum so as to reinforce the resistance of the alloy to electrical erosion. This is constituted in particular by iridium at a concentration lying in the range 5% to 15% by weight, rhodium at a concentration lying in the range 0% to 15%, the concentration of the majority element (specifically platinum) being adjusted accordingly.

In a first example of a platinum alloy composition for use in manufacturing an end portion of a central electrode of a spark plug for a spark ignition engine, the composition essentially comprises, in percentage by weight:

about 5% to 15% iridium; and

about 0.1% to 5% of an element selected from the group comprising: hafnium, zirconium, and mixtures thereof.

In a second example of a platinum alloy composition for making an end portion of a central electrode of a spark plug for a spark ignition engine, the composition essentially comprises in percentage by weight:

about 5% to 15% iridium;

about 0% to 15% rhodium; and

about 0.1% to 5% of an element selected from the group comprising: hafnium, zirconium, and mixtures thereof.

In yet another embodiment of the invention, the central electrode of the spark plug is constituted entirely of the platinum alloy of the invention. Nevertheless, given its extremely high cost price, this embodiment is not preferred.

1/ A platinum alloy composition for the central electrode of a spark plug for a spark ignition engine, the composition further comprising in percentage by weight:
about 5% to 15% iridium; and
about 0.1% to 5% of an element selected from the group comprising: hafnium, zirconium, and mixtures thereof.

2/ A composition according to claim 1, further comprising not more than 15% rhodium.

3/ A composition according to claim 1 or claim 2, in which the element is introduced in the form of a metal.

4/ A composition according to claim 1 or claim 2, in which the element is present in the form of a metal.

5/ A composition according to any one of claims 1 to 4, in which the composition is fitted to an end portion (11) of the central electrode (1).

6/ A spark plug for a spark ignition engine, the spark plug comprising a central electrode (1) whose end portion (11) is made of a platinum alloy composition according to any one of claims 1 to 5.
